(19) United States
(12) Patent Application Publication
(10) Pub. No.: US 2013/0175945 A1
(43) Pub. Date: Jul. 11, 2013

(54) CIRCUIT AND METHOD FOR PREHEATING FILAMENTS AND BALLAST

(71) Applicants: Yuancheng Guo, Guangzhou (CN); Wei Chen, Guangdong (CN); Jie Hong Jian, Guangdong (CN); Hui Ling Xu, Guangdong (CN)

(72) Inventors: Yuancheng Guo, Guangzhou (CN); Wei Chen, Guangdong (CN); Jie Hong Jian, Guangdong (CN); Hui Ling Xu, Guangdong (CN)

(73) Assignee: OSRAM AG, Muenchen (DE)

(21) Appl. No.: 13/811,281

(22) PCT Filed: Sep. 1, 2011
(86) PCT No.: PCT/EP2011/065121

§ 371 Date: Jan. 21, 2013

(30) Foreign Application Priority Data
Sep. 21, 2010 (CN) 201010292505.1

(51) Int. Cl. H05B 41/04

(52) U.S. Cl. CPC H05B 41/04
USPC 315/291

(57) ABSTRACT

A circuit for preheating filaments may include: a transistor; a first winding, one terminal of which being electrically connected with a collector of the transistor, and the other terminal being connected to an input of a power source; a second winding, one terminal of which being electrically connected with an emitter of the transistor, the other terminal being electrically connected with a base of the transistor, and the second winding being coupled with the first winding in a self-excitation mode; one or more load windings respectively connected with the filaments in series, and each of which being coupled with the first winding in a flyback mode; and a delay switch, configured to change into an on state from an off state when a trigger signal with a predetermined delay is received, so as to turn off the transistor.

### FIELD OF THE INVENTION

The present invention relates to a ballast of a discharge lamp, and particularly to a circuit and a method for preheating filaments in the ballast of the discharge lamp.

### BACKGROUND OF THE INVENTION

The ballast may provide a controllable power source for the discharge lamp. The ballast generally includes a pre-regulator and a half-bridge circuit. After the AC power from the electric network is rectified by the pre-regulator, it drives the half-bridge circuit and supplies power for the discharge lamp.

It is generally necessary to preheat the filaments before the discharge lamp is triggered to start up. A transformer with an integrated circuit controller may be used to preheat the filaments, so that it is possible to precisely control the preheating energy and to precisely cut off a preheating current after the filaments are preheated. However, the transformer with the integrated circuit controller has a high cost and a complicated structure.

A circuit containing a PTC (Positive Temperature Coefficient semiconductor material) resistor may also be used to preheat the filaments. Although the circuit containing the PTC resistor has a low cost, there is large tolerance on resistance and parasitic capacitance, thus affecting the preheating energy and a resonance curve. Further, from a power consumption saving point of view, it is very difficult for the circuit containing the PTC resistor to precisely realize a function of cutting off the preheating current.

There is a need of a circuit and a method for preheating filaments with a low cost, which can both preheat the filaments precisely, and cut off the preheating current precisely after the filaments are preheated, and thus the power consumption is saved.

### SUMMARY OF THE INVENTION

An embodiment of the invention is a circuit for preheating filaments, including: a transistor; a first winding, one terminal of which being electrically connected with a collector of the transistor, and the other terminal being connected to an input of a power source; a second winding, one terminal of which being electrically connected with an emitter of the transistor, the other terminal being electrically connected with a base of the transistor, and the second winding being coupled with the first winding in a self-excitation mode; one or more load windings respectively connected with the filaments in series, and each of which being coupled with the first winding in a flyback mode; and a delay switch, which changes into an on state from an off state when a trigger signal with a predetermined delay is received, so as to turn off the transistor.

An embodiment of the invention is a method for preheating filaments, which preheats the filaments using the above-described circuit for preheating filaments, including: setting, when the power is on, the delay switch in the circuit for preheating filaments to the off state to start up the circuit for preheating filaments; and sending, after passing a predetermined delay, a trigger signal to the delay switch in the circuit for preheating filaments, and setting the delay switch to the on state to cut off the circuit for preheating filaments.

An embodiment of the invention is a ballast including the above-described circuit for preheating filaments, and further including a half-bridge circuit, wherein the circuit for preheating filaments is connected with the half-bridge circuit in parallel.

### BRIEF DESCRIPTION OF THE DRAWINGS

The above and other objects, characteristics and advantages of the invention will be more easily understood with reference to the description of embodiments of the invention in combination with the accompanying drawings below. In the figures, identical or corresponding technical features or components are denoted by identical or corresponding reference numbers.

FIG. 1 illustrates a structural block diagram of a ballast according to an embodiment of the invention;

FIG. 2 illustrates a structural block diagram of a ballast according to another embodiment of the invention;

FIG. 3 illustrates a circuit diagram of a circuit for preheating filaments according to an embodiment of the invention;

FIG. 4 illustrates a circuit diagram of a circuit for preheating filaments according to another embodiment of the invention; and

FIG. 5 illustrates a flowchart of a method for preheating filaments using a circuit for preheating filaments.

### DETAILED DESCRIPTION OF THE INVENTION

Embodiments of the invention are described with reference to the figures below. It should be noted that for the sake of clarity, components and processing less relevant to the invention and known to those skilled in the art are omitted in the figures and descriptions.

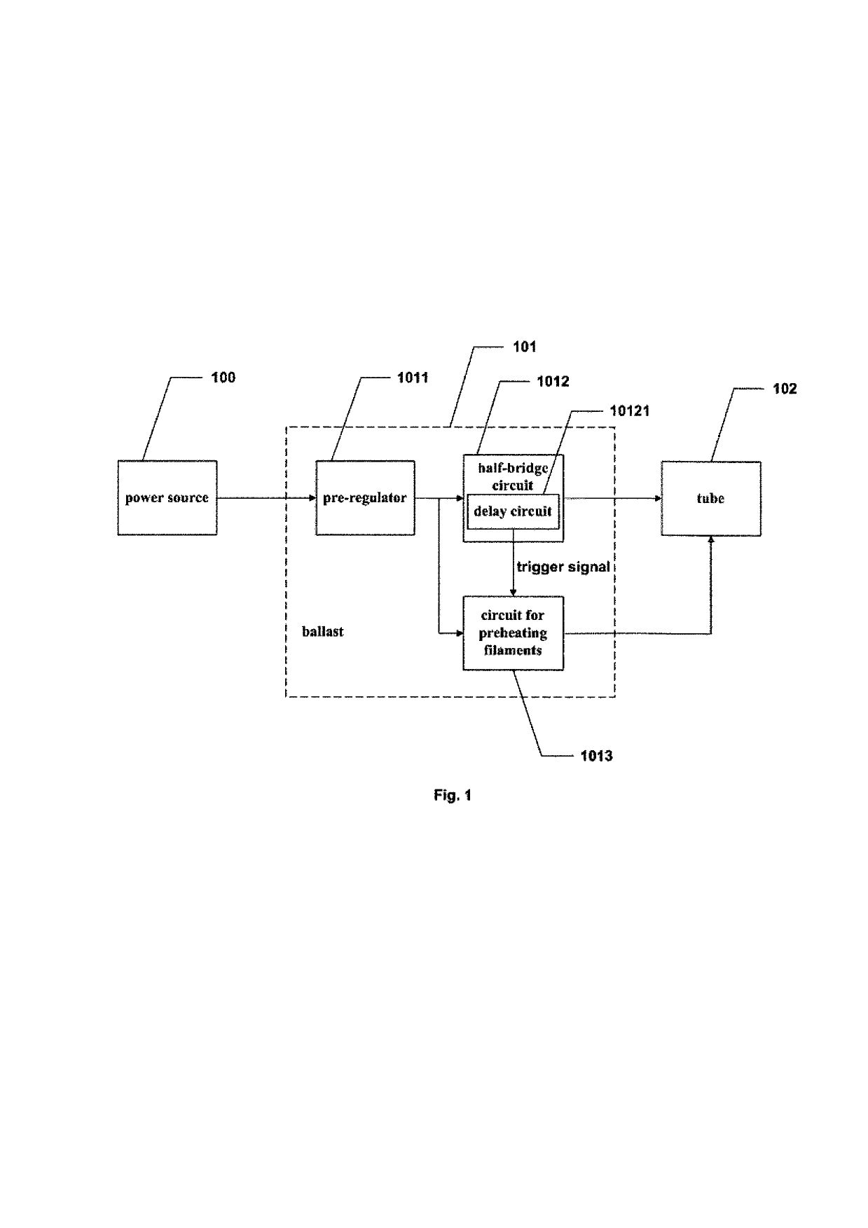

Referring to FIG. 1, it illustrates a block diagram of a ballast according to an embodiment of the invention. As shown in FIG. 1, a ballast 101 includes a pre-regulator 1011, a half-bridge circuit 1012 and a circuit for preheating filaments 1013. After the AC power from the electric network is rectified by the pre-regulator 1011 it drives the half-bridge circuit 1012 and supplies power for a tube 102 of a discharge lamp. The circuit for preheating filaments 1013 is connected with the half-bridge circuit 1012 in parallel, and preheats the filaments in the tube 102 of the discharge lamp.

The half-bridge circuit 1012 of the ballast 101 includes a delay circuit 10121 which may set a predetermined latency for the circuit for preheating filaments 1013. The latency can be set in advance, provided that the filaments may be preheated to a state of electronic emission after passing the latency. When the ballast 101 is powered on at the beginning, the half-bridge circuit 1012 does not operate and the circuit for preheating filaments 1013 operates; after passing the predetermined latency, the delay circuit 10121 sends a trigger signal to the circuit for preheating filaments 1013 to completely cut off the circuit for preheating filaments 1013, simultaneously the half-bridge circuit 1012 begins to operate to supply power for the discharge lamp, thus starting up the tube 102 of the discharge lamp and maintaining normal operation of the tube 102 of the discharge lamp. The delay circuit 10121 may achieve the purpose of latency by triggering a bi-directional diode. Those skilled in the art may understand that the delay circuit 10121 may also be implemented in other manners.

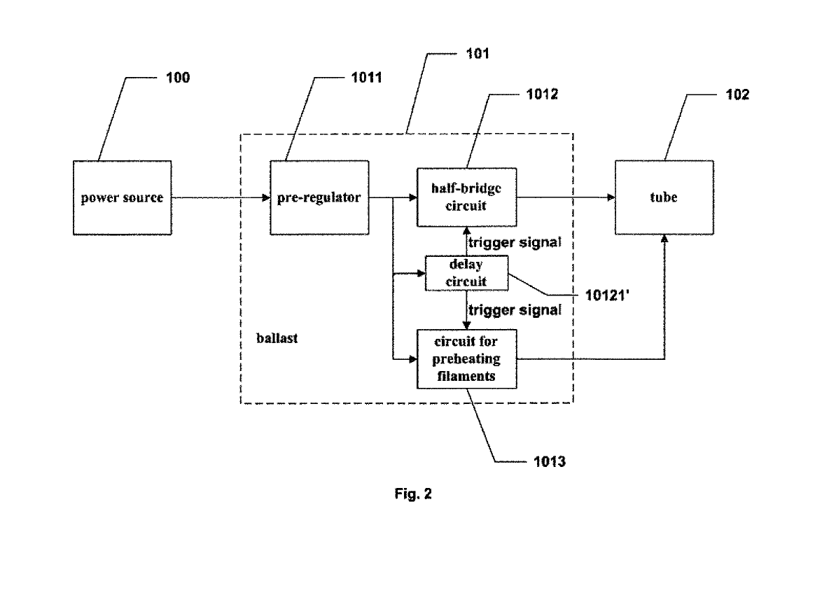

Referring to FIG. 2, it illustrates a structural block diagram of a ballast according to another embodiment of the invention. The ballast as shown in FIG. 2 is substantially same as that shown in FIG. 1, except that a delay circuit 10121′ is out of the half-bridge circuit 1012 and is connected with the half-bridge circuit 1012 and the circuit for preheating filaments 1013 in parallel respectively. When the ballast 101 is powered on at the beginning, the half-bridge circuit 1012 does not operate and the circuit for preheating filaments 1013 operates; after passing a predetermined latency, the delay circuit 10121′ sends a trigger signal to the circuit for preheating filaments 1013 to completely cut off the circuit for preheating filaments 1013, simultaneously the delay circuit 10121′ sends a trigger signal to the half-bridge circuit 1012 to make the half-bridge circuit 1012 begin to operate so as to supply power for the discharge lamp, and thus starting up the tube 102 of the discharge lamp and maintaining normal operation of the tube 102 of the discharge lamp. The delay circuit 10121′ may achieve the purpose of latency by triggering a bi-directional diode. Those skilled in the art may understand that the delay circuit 10121′ may also be implemented in other manners.

Those skilled in the art may understand that the latency may also be set in other manners, provided that the circuit for preheating filaments 1013 can be cut off and the half-bridge circuit 1012 of the ballast 101 can be turned on after passing the predetermined latency.

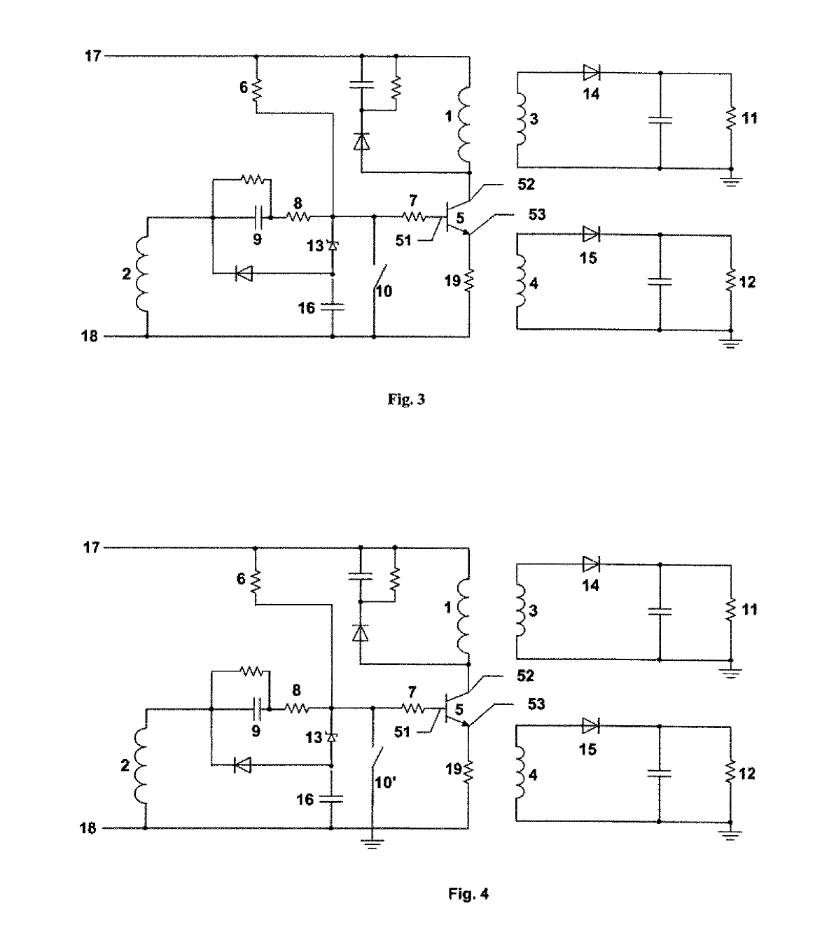

Referring to FIG. 3, it illustrates a circuit diagram of a circuit for preheating filaments according to an embodiment of the invention. A circuit for preheating filaments 1013 is electrically connected with a first input terminal 17 and a second input terminal 18 of a power source. The circuit for preheating filaments 1013 includes a first winding 1, a second winding 2, a third winding 3, a fourth winding 4, a transistor 5, a first resistor 6, a second resistor 7, a third resistor 8, a fourth resistor 19, a first capacitor 9, a second capacitor 16, a Zener diode 13, a first rectifier diode 14, a second rectifier diode 15 and a delay switch 10. The circuit for preheating filaments 1013 preheats a first filament 11 and a second filament 12.

One terminal of the first resistor 6 is electrically connected with the first input terminal 17 of the power source, and the other terminal is electrically connected with a cathode of the Zener diode 13. One terminal of the second resistor 7 is electrically connected with a base 51 of the transistor 5, and the other terminal is electrically connected with the cathode of the Zener diode 13. One terminal of the first winding 1 is electrically connected with the first input terminal 17 of the power source, and the other terminal is electrically connected with a collector 52 of the transistor 5. One terminal of the fourth resistor 19 is electrically connected with an emitter 53 of the transistor 5, and the other terminal is electrically connected with the second input terminal 18 of the power source. The third resistor 8, the first capacitor 9 and the second winding 2 are connected in series, wherein one terminal of the third resistor 8 is electrically connected with the cathode of the Zener diode 13, and one terminal of the second winding 2 is electrically connected with the second input terminal 18 of the power source. One terminal of the second capacitor 16 is electrically connected with the second input terminal 18 of the power source, and the other terminal is electrically connected with an anode of the Zener diode 13. One terminal of the delay switch 10 is electrically connected with the base 51 of the transistor 5 via the second resistor 7, and the other terminal is electrically connected with the emitter 53 of the transistor 5 via the fourth resistor 19. When the delay switch 10 receives a trigger signal with a predetermined delay, it changes into an on state from an off state, shorts the base 51 with the emitter 53 of the transistor 5 to turn off the transistor 5, and thereby cutting off the circuit for preheating filaments 1013. The trigger signal, which starts up the half-bridge circuit 1012 of the ballast 101 simultaneously, may be generated by the delay circuit 10121 or 10121′.

The first winding 1 is coupled with the third winding 3 in a flyback mode, coupled with the fourth winding 4 in a flyback mode, and coupled with the second winding 2 in a self-excitation mode. One terminal of the third winding 3 is electrically connected with an anode of the first rectifier diode 14, and the other terminal is grounded. One terminal of the first filament 11 is electrically connected with a cathode of the first rectifier diode 14, and the other terminal is grounded. One terminal of the fourth winding 4 is electrically connected with an anode of the second rectifier diode 15, and the other terminal is grounded. One terminal of the second filament 12 is electrically connected with a cathode of the second rectifier diode 15, and the other terminal is grounded.

When the discharge lamp is powered on, the delay switch 10 is in the off state, and thus only the circuit for preheating filaments 1013 begins to operate in order to preheat the filaments in the tube 102 of the discharge lamp. After passing a predetermined latency, the delay switch 10 changes into the on state from the off state, shorts the base 51 with the emitter 53 of the transistor 5 to turn off the transistor 5, and thereby completely cutting off the circuit for preheating filaments 1013; simultaneously the half-bridge circuit 1012 of the ballast 101 begins to operate, so as to supply power for the discharge lamp, and thus starting up the tube 102 of the discharge lamp and maintaining the normal operation of the tube 102 of the discharge lamp. Since the circuit for preheating filaments 1013 is completely turned off during the normal operation of the tube 102 of the discharge lamp, power consumption may be saved.

Referring to FIG. 4, it illustrates a circuit diagram of a circuit for preheating filaments according to another embodiment of the invention. The circuit for preheating filaments shown in FIG. 4 is substantially same as that shown in FIG. 3, except connection relation of a delay switch 10′. As shown in FIG. 4, one terminal of the delay switch 10′ is electrically connected with the base 51 of the transistor 5 via the second resistor 7, and the other terminal is grounded. When the delay switch 10′ receives a trigger signal with a predetermined latency, it changes into an on state from the off state, grounds the base 51 of the transistor 5 in order to turn off the transistor 5, and thus cutting off the circuit for preheating filaments 1013. The trigger signal, which simultaneously starts up the half-bridge circuit 1012 of the ballast 101, may be generated by the delay circuit 10121 or 10121′.

Those skilled in the art may understand that the delay switch may be implemented in other manners, provided that the circuit for preheating filaments can be cut off after the trigger signal with the predetermined latency is received.

Operation flow of the circuit for preheating filaments 1013 is described in details below.

When the discharge lamp is powered on, an input voltage V_{bus} between the first input terminal 17 and the second input terminal 18 of the power source applies a positive bias to a circuit at the base 51 side of the transistor 5 via the first resistor 6, resulting in a very small base current I_{b}, and thus causing the transistor 5 to turn on. Due to current amplification effect of the transistor 5, a collector current I_{c} generated by a circuit at the collector 52 side of the transistor 5 is multiple of the base current I_{b}. The collector current I_{c} flows through the first winding 1, causing a voltage on the first winding 1 to increase gradually, and thus inducing a positive feedback voltage on the second winding 2. The positive feedback voltage induced on the second winding 2 is applied to the circuit at the base 51 side of the transistor 5, and thus causing the base current I_{b} to increase gradually. Due to the current amplification effect of the transistor 5, the collector current I_{c} also increases gradually. Therefore, the transistor 5 reaches a saturation state from a conduction amplification state rapidly due to series of positive feedback.

Meanwhile, the positive feedback voltage induced on the second winding 2 can charge the first capacitor 9, causing a voltage on the first capacitor 9 to increase gradually, while the voltage on the base 51 of the transistor 5 to decrease gradually, and thus causing the base current I_{b} to decrease gradually and the transistor 5 to quit the saturation state. Since the base current I_{b} decreases gradually, the collector current I_{c} also decreases gradually, thus causing the voltage on the first winding 1 to decrease gradually. Due to series of positive feedback, the transistor 5 cuts off rapidly.

When the transistor 5 cuts off, the collector current I_{c} thereof becomes zero. At this time, the voltage on the first winding 1 will be inverse, and the positive feedback voltage induced on the second winding 2 will be also inverse. The inverse positive feedback voltage induced on the second winding 2 will charge the second capacitor 16. When the transistor 5 cuts off, the first rectifier diode 14 and the second rectifier diode 15 turns on respectively, and the energy stored in the first winding 1 is transferred to the first filament 11 and the second filament 12 via the third winding 3 and the fourth winding 4 respectively, so as to preheat the first filament 11 and the second filament 12.

When the transistor 5 cuts off, the input voltage V_{bus} between the first input terminal 17 and the second input terminal 18 of the power source inversely charges the first capacitor 9 via the first resistor 6 again and gradually increases the voltage of the circuit at the base 51 side of the transistor 5, thus causing the transistor 5 to turn on again and to reach the saturation state again, and the circuit for preheating filaments 1013 oscillates repeatedly as that.

When the transistor 5 is in the conduction amplification state, the relation between the voltage V₂ induced on the second winding 2 and the voltage V₁ on the first winding 1 is the following: V₂=n₂/n₁*V₁, wherein n₁ is the number of turns of the first winding 1, and n₂ is the number of turns of the second winding 2. Since RC time is very short, e.g. about 0.1 μs, storage time of the transistor 5 will not affect on time Tₒₙ thereof. The on time Tₒₙ of the transistor 5 is determined only by the following two factors: one is capacitance value of the first capacitor 9, resistance values of the second resistor 7 and the third resistor 8, and the other is turn ratio of n₁:n₂ between the first winding 1 and the second winding 2.

If the positive feedback voltage induced on the second winding 2 is too large at the beginning and thus resulting in a too large base current I_{b} generated by the circuit at the base 51 side of the transistor 5, then the value of the base current I_{b} may be limited by the Zener diode 13. The smaller the value of the Zener diode 13 is, the shorter the on time Tₒₙ of the transistor 5 is. The Zener diode 13 is optional, that is, the Zener diode may be not used.

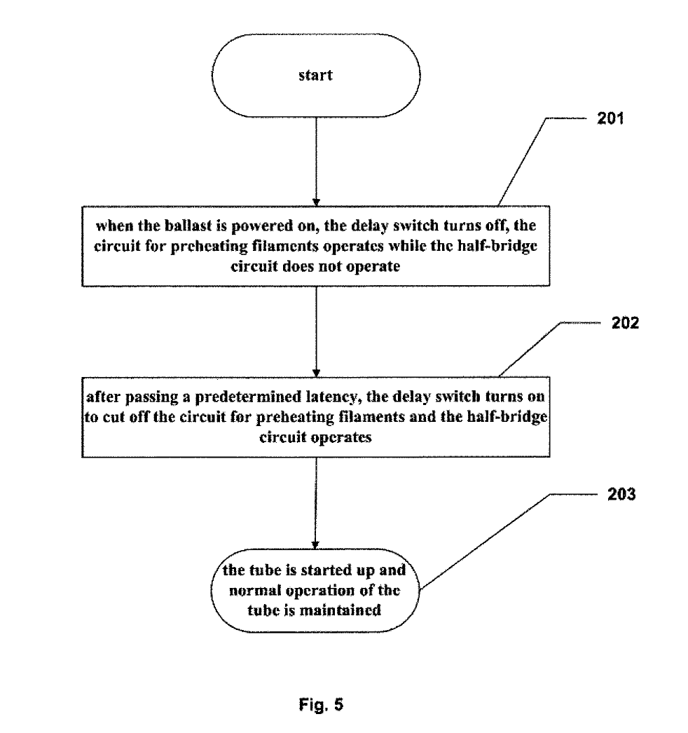

Referring to FIG. 5, it illustrates a flowchart of a method for preheating the filaments using a circuit for preheating filaments. As shown in FIG. 5, in Step 201, when the ballast 101 is powered on, the delay switch 10 or 10′ of the circuit for preheating filaments 1013 is in the off state, and the circuit for preheating filaments 1013 operates while the half-bridge circuit 1012 does not; in Step 202, after passing a predetermined latency, the delay circuit 10121 or 10121′ sends a trigger signal to the delay switch 10 or 10′ of the circuit for preheating filaments 1013, making the delay switch 10 or 10′ change into the on state to turn off the transistor 5, and thus completely cutting off the circuit for preheating filaments 1013, simultaneously the half-bridge circuit 1012 begins to operate so as to supply power for the discharge lamp; and in step 203, the tube 102 of the discharge lamp is started up, and normal operation of the tube 102 of the discharge lamp is maintained.

The invention has been described with reference to specific embodiments in the above specification. However, those skilled in the art will understand that various modifications and variations can be made without departing from the scope of the invention defined by the appended claims.

1. A circuit for preheating filaments, comprising:
a transistor;
a first winding, one terminal of which being electrically connected with a collector of the transistor, and the other terminal being connected to an input of a power source;
a second winding, one terminal of which being electrically connected with an emitter of the transistor, the other terminal being electrically connected with a base of the transistor, and the second winding being coupled with the first winding in a self-excitation mode;
one or more load windings respectively connected with the filaments in series, each of which being coupled with the first winding in a flyback mode; and
a delay switch, configured to change into an on state from an off state when a trigger signal with a predetermined delay is received, so as to turn off the transistor.

2. The circuit for preheating filaments as claimed in claim 1, wherein both terminals of the delay switch are connected with the base and the emitter of the transistor respectively.

3. The circuit for preheating filaments as claimed in claim 1, wherein one terminal of the delay switch is electrically connected with the base of the transistor, and the other terminal is grounded,

4. The circuit for preheating filaments as claimed in claim 1, wherein the trigger signal is generated by a delay circuit, and the trigger signal simultaneously starts up a half-bridge circuit being connected with the circuit for preheating filaments in parallel.

5. The circuit for preheating filaments as claimed in claim 4, wherein the delay circuit is included in the half-bridge circuit.

6. The circuit for preheating filaments as claimed in claim 4, wherein the delay circuit is out of the half-bridge circuit, and is connected with the half-bridge circuit and the circuit for preheating filaments in parallel respectively.

7. The circuit for preheating filaments as claimed in claim 1, further comprising one or more capacitors connected in series between the second winding and the base of the transistor.

8. The circuit for preheating filaments as claimed in claim 1, further comprising one or more resistors connected in series between the second winding and the base of the transistor.

9. The circuit for preheating filaments as claimed in claim 1, further comprising a Zener diode, a cathode of which being electrically connected with the base of the transistor, and an anode of the Zener diode being electrically connected with the emitter of the transistor.

10. A method for preheating filaments using a circuit for preheating filaments, the circuit comprising: a transistor; a first winding, one terminal of which being electrically connected with a collector of the transistor, and the other terminal being connected to an input of a power source; a second winding, one terminal of which being electrically connected with an emitter of the transistor, the other terminal being electrically connected with a base of the transistor, and the second winding being coupled with the first winding in a self-excitation mode; one or more load windings respectively connected with the filaments in series, each of which being coupled with the first winding in a flyback mode; and a delay switch, configured to change into an on state from an off state when a trigger signal with a predetermined delay is received, so as to turn off the transistor,
the method comprising:
setting, when power is on, the delay switch in the circuit for preheating filaments to an off state to start up the circuit for preheating filaments; and
sending, after passing a predetermined delay, a trigger signal to the delay switch in the circuit for preheating filaments, and setting the switch to an on state to cut off the circuit for preheating filaments.

11. A ballast, comprising;
a circuit for preheating filaments, the circuit comprising:
a transistor;
a first winding, one terminal of which being electrically connected with a collector of the transistor, and the other terminal being connected to an input of a power source;
a second winding, one terminal of which being electrically connected with an emitter of the transistor, the other terminal being electrically connected with a base of the transistor, and the second winding being coupled with the first winding in a self-excitation mode;
one or more load windings respectively connected with the filaments in series, each of which being coupled with the first winding in a flyback mode; and
a delay switch, configured to change into an on state from an off state when a trigger signal with a predetermined delay is received, so as to turn off the transistor;
and the ballast further comprising a half-bridge circuit, wherein the circuit for preheating filaments is connected with the half-bridge circuit in parallel.

12. The circuit for preheating filaments as claimed in claim 2, further comprising one or more capacitors connected in series between the second winding and the base of the transistor.

13. The circuit for preheating filaments as claimed in claim 3, further comprising one or more capacitors connected in series between the second winding and the base of the transistor.

14. The circuit for preheating filaments as claimed in claim 4, further comprising one or more capacitors connected in series between the second winding and the base of the transistor.

15. The circuit for preheating filaments as claimed in claim 2, further comprising one or more resistors connected in series between the second winding and the base of the transistor.

16. The circuit for preheating filaments as claimed in claim 3, further comprising one or more resistors connected in series between the second winding and the base of the transistor.

17. The circuit for preheating filaments as claimed in claim 4, further comprising one or more resistors connected in series between the second winding and the base of the transistor.

18. The circuit for preheating filaments as claimed in claim 2, further comprising a Zener diode, a cathode of which being electrically connected with the base of the transistor, and an anode of the Zener diode being electrically connected with the emitter of the transistor.

19. The circuit for preheating filaments as claimed in claim 3, further comprising a Zener diode, a cathode of which being electrically connected with the base of the transistor, and an anode of the Zener diode being electrically connected with the emitter of the transistor.

20. The circuit for preheating filaments as claimed in claim 4, further comprising a Zener diode, a cathode of which being electrically connected with the base of the transistor, and an anode of the Zener diode being electrically connected with the emitter of the transistor.
